(19) United States
(12) Patent Application Publication
(10) Pub. No.: US 2006/0225955 A1
(43) Pub. Date: Oct. 12, 2006

(54) Breakdown self propelled elevating work platform

(76) Inventor: Daniel George Murphy, Paso Robles, CA (US)

Correspondence Address: Mr. Daniel G. Murphy, 5905 Monterey Road, Paso Robles, CA, 93446, US

(21) Appl. No.: 11/397,665

(22) Filed: Apr. 3, 2006

Related U.S. Application Data
(60) Provisional application No. 60/670,038, filed on Apr. 11, 2005.

(51) Int. Cl. E06C 1/00; E04G 3/32

(52) U.S. Cl. 182/69.5; 182/113

(57) ABSTRACT

A scissor lift style elevating work platform mounted on an air powered self-propelled wheeled chassis that when disassembled may be passed through a small diameter access hole and reassembled for immediate use. The machine is air-controlled producing no toxic gases and the machine has no electrical equipment or circuits. The wheel assemblies are bolted to the base and cannot be rotated. Steering is accomplished by rotating opposite pairs of wheels in counter directions or by braking one pair of wheels and powering the other pair so that the machine is forced to skid the tires in order to turn. This feature enhances the mobility of the machine while reducing the complexity of assembly. The machine is designed to reduce the accumulation of blast abrasive on the elevated platform by use of perforated decking that prevents the build up of abrasive on the decking. The machine design reduces accumulation of blast abrasive and paint on the lower scissor linkage slides by use of protective shields. The scissors linkages utilizes a system of hinge pin mounted hooks that provide efficient routing of supply lines to the platform.

### BRIEF DESCRIPTION OF THE DRAWINGS

FIG. 1 is a frontal view of the machine in a lowered position. FIG. 1-1a is the mobile base consisting of base trusses further described in FIG. 3. FIG. 1-1b points to ballast tanks provided for increased stability. The drive wheels FIG. 1-1c on each corner of the platform base are driven by hydraulic motors FIG. 1-1d that are powered by an air driven hydraulic pump FIG. 1-1e. The hydraulic pump also powers the hydraulic lifting cylinder shown on FIG. 2-2a. The drive wheel assemblies FIG. 1-1f are bolted to the base trusses through a Bolting Plate FIG. 5-5a to facilitate rapid disassembly and reassembly. An air motor driven hydraulic pump that is controlled by pneumatic and hydraulic valves powers the machine. FIG. 1-1g points to the lifting and driving controls on the elevated work platform that allow the machine to be operated from the platform in a raised and extended position. A second set of controls FIG. 1-1k are mounted on the mobile base at ground level. The air powered pump and hydraulic drives are non-spark producing, requiring no external electrical power source to operate. FIG. 1-1h points to the platform for supporting workers. The platform consists of perforated aluminum planks providing flooring supported by tubular members. The perforated plank flooring helps to prevent buildup of sand and blasting debris. The platform is fabricated from aluminum for reduced weight aloft to increase stability and to lower power and structural requirements. FIG. 1-1i points to the hand railing encompassing the platform to prevent personnel from falling from the platform. The machine utilizes an over-tilt air operated safety shut down device FIG. 1-1j detailed in FIG. 11. This shutdown device contains an inverted vertical pendulum that may be set to activate at predetermined angular values. The device will immediately shut down power to critical machine functions if the machine is tilted to a predetermined value and in the event of loss of air pressure supply. The reserve safety air tank will allow safe descent of the platform.

FIG. 2 is a frontal view of the platform in an extended position. FIG. 2-2a points to the hydraulic lifting cylinder for the extension of the scissor linkages. FIG. 2-2b points to the conveyance hooks detailed in FIGS. 6 and 7 for the lifting of heavy large diameter hoses necessary for blasting operations and other support utilities to the platform. FIG. 2-2c points to the Pin Hinge Assemblies detailed in FIG. 6 that connect the machine scissor linkages.

FIG. 3 is an isometric view of the mobile base. This drawing points to the drive wheel 3a; chain sprocket 3b; hydraulic motor 3c; wheel axle 3d; bolting plate and truss ends 3e; tubular truss element 3f; lower scissors guides 3g and scissor guide protective shield 3h. The protective shield is detailed in FIG. 4.

FIG. 4 is a lower scissor guide protective shield. The shield protects the lower sliding scissor linkage from falling debris that tends to congeal on the scissor guides. The shields consist of a steel slide 4a; steel plate clamp 4b; rubber shield 4c; metal scraper 4d and metal cross pin 4e that connects to the lower sliding scissor linkage.

FIG. 5 is the Bolting Plate and Truss Ends indicating how the mobile base trusses are assembled. FIG. 5a is a truss end; 5b is a bolting flange; 5c is a threaded stud; 5d is the mounting surface for motor and axle; 5e is the bolting plate; 5f is a tapered nut; and 5g is a tapered hole for the threaded stud.

FIG. 6 is the Pin Hinge Assembly showing how the machine scissor linkages are connected with the hinge assembly. FIGS. 6a are the scissor linkage structural member ends; FIG. 6b is the conveyance hook connected to the pin assembly that enables heavy hoses and support utilities to be lifted to the elevated work platform without entanglement in the scissor structure. FIG. 6c is the bearing housing for the hollow shaft; FIG. 6d is the shoulder on the hollow shaft; 6e is a lock nut; 6f is a threaded rod; 6g hollow shaft support tube; 6h safety tube coupling and 6i spring plunger shaft retainer.

FIG. 7 is an isolated view of the Pin Hinge assembly. The assembly consists of FIG. 7-7a threaded rod; 7-7b recess in hollow shaft; 7-7c hollow shaft; 7-7d shoulder on shaft; 7-7e lock nut; 7-7f coupling nut; 7-7g bent solid rod for conveyance hook with attached rings.

FIG. 8 is an exploded view of the Pin Hinge assembly and scissor linkage ends. FIG. 8-8a is a lock nut; 8-8b is the bearing housing for the hollow shaft; 8-8c is the safety tube coupling; 8-8d machined end of the support tube; 8-8e spring plunger shaft retainer; 8-8f recess in hollow shaft; 8-8i threaded rod; 8-8j lock nut; and 8-8k bent solid rod hose hanger.

FIG. 9 is a cross section of the Pin Hinge Assembly and end view of the scissor linkage structural members. FIG. 9-9a is a lock nut; 9-9b hollow shaft support tube; 9-9c machined end of tube; 9-9d hollow shaft; 9-9e lock nut; 9-9f hose hanger; 9-9g threaded rod; 9-9h bearing housing for hollow shaft; 9-9i scissor linkage ends; 9-9j hollow shaft support tube; 9-9k safety tube coupling; 9-9l spring plunger shaft retainer; and 9-9i scissor linkage ends.

FIG. 10 is an isometric view of the access platform. FIG. 10-10a is a plank retainer angle; 10-10b perforated aluminum plank; 10-10c channel clip; 10-10d retainer clip; 10-10e base support tube; 10-10f plank guide angle; 10-10g access step; 10-10h base support tube; 10-10i bolting flange; 10-10j post stop; 10-10k handrail post receiver tube; 10-10l handrail post; 10-10m receiver hole for threaded rod; 10-10n threaded rod; 10-10o square tube stop; 10-10p handrail tubes; and 10-10q handrail retainer tubes.

FIG. 11 is an isometric view of the Safety Tilt Switch. 11-11a is the base; 11-11b pneumatic valve; 11-11c micro switch; 11-11d weld; 11-11e block; 11-11f cylinder; 11-11g washer with tapered edge; 11-11h lock nut; 11-11i cylinder; 11-11j cap; 11-11k vent; 11-11l threaded rod; 11-11m lock nut; 11-11n lock nut; 11-11o threaded rod; 11-11p lock nut; 11-11q lock nut; 11-11r gasket; 11-11s smooth head screw; 11-11t nut welded in position; and 11-11u lock nut.

FIG. 12 is a Conceptual Cross Section of the Safety Tilt Switch. FIG. 12-12a is a pneumatic valve; 12-12b is a solid cylinder; and 12-12c is a threaded rod. In the event the elevated platform reaches a predetermined angle, the pendulum at point A separates from point B which creates pneumatic output and this immediately shuts down the air supply. This stops the operation of the machine.

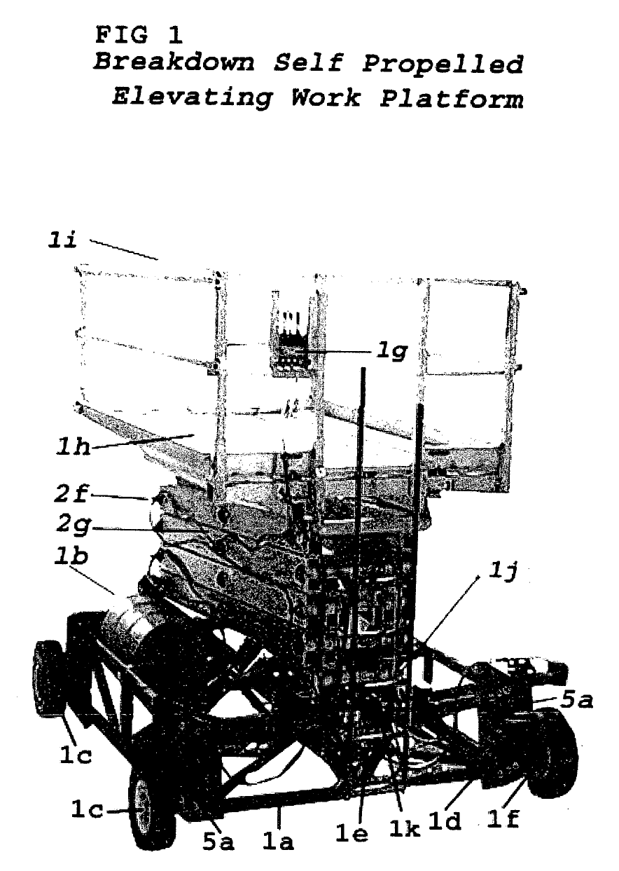

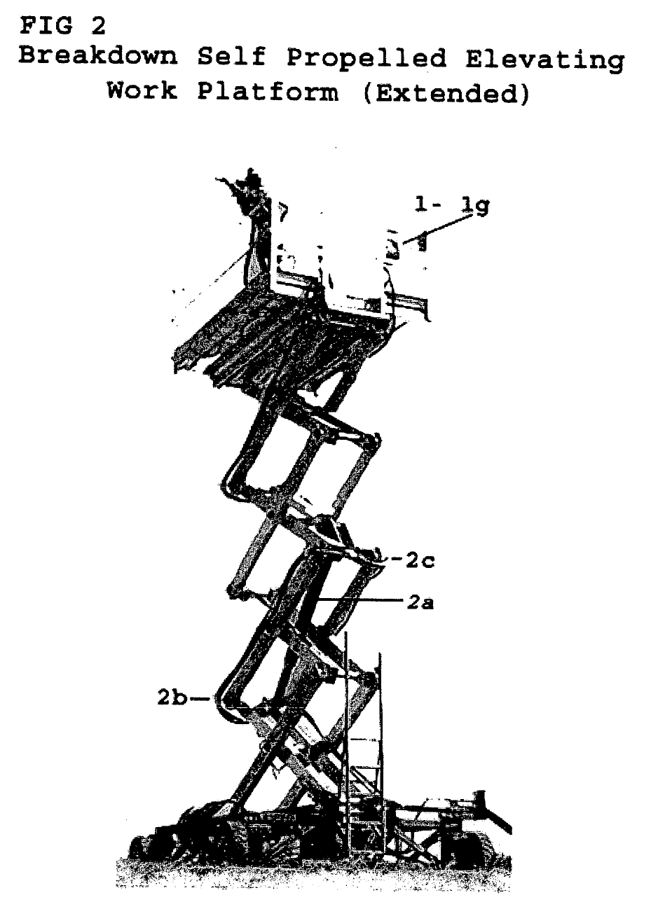

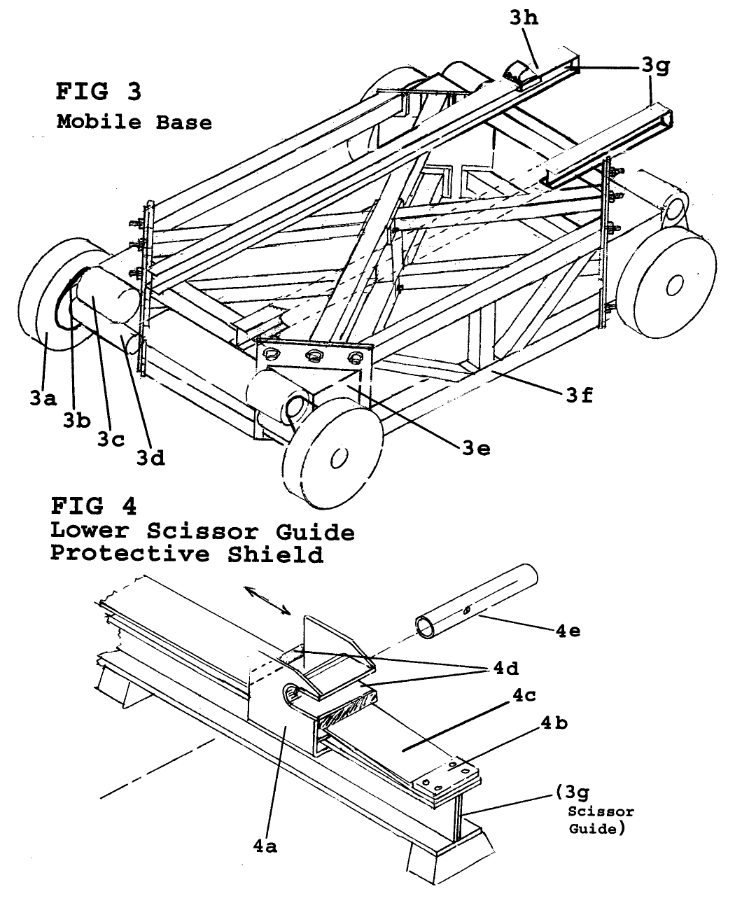

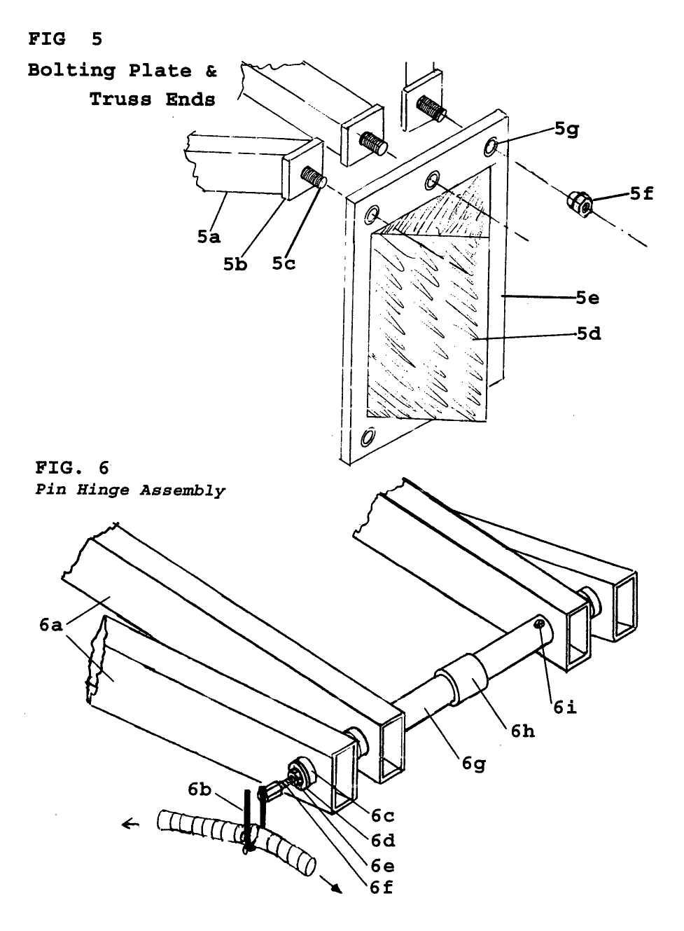

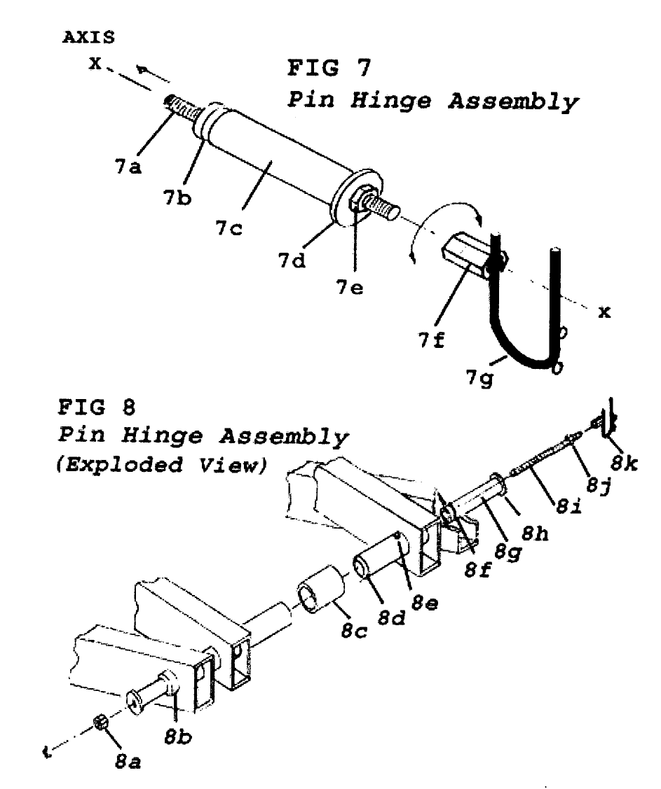

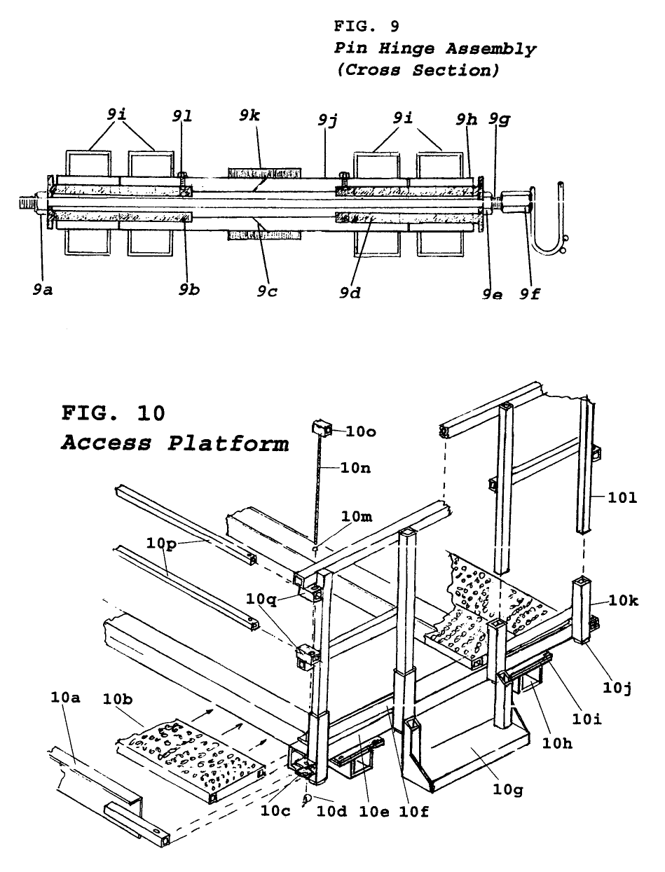

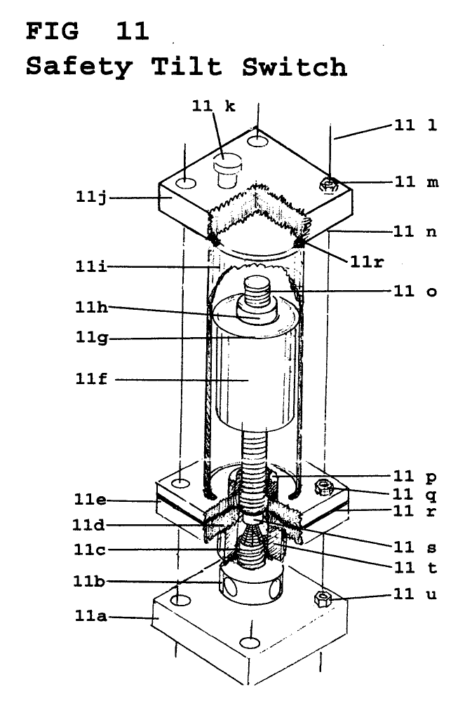

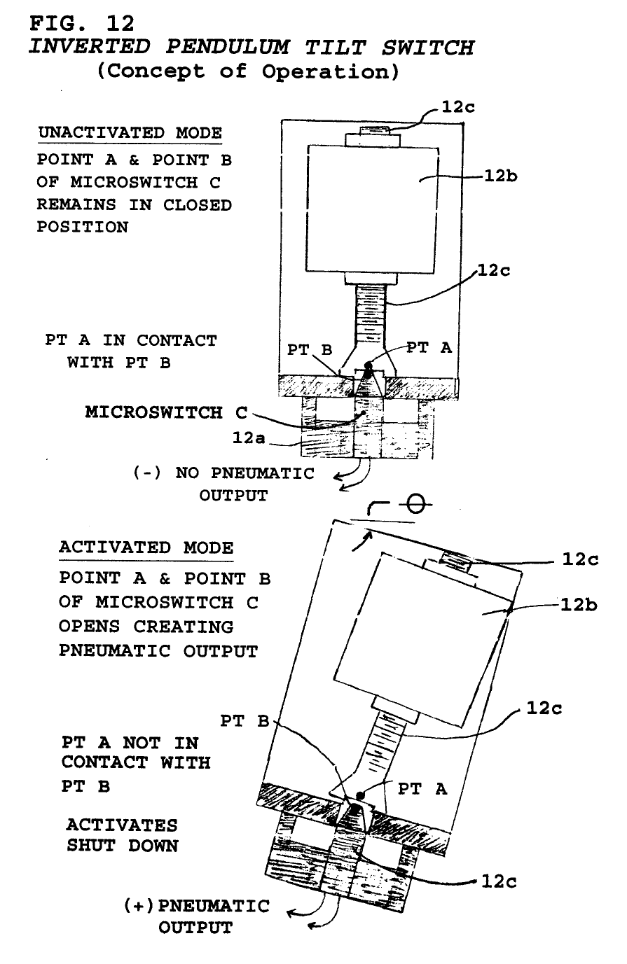

I Claim:

1. A platform for supporting workers. The platform consists of perforated aluminum planks providing flooring supported by tubular members. A hand railing encompasses the platform to prevent personnel from falling from the platform. The platform is fabricated from aluminum for reduced weight aloft for increased stability and for lower power and structural requirements.

2. A mobile base. The platform mobile base structure includes ballast tanks for increased stability. The drive wheels on each corner of the platform base are driven by hydraulic motors that are powered by an air driven hydraulic pump. The hydraulic pump also powers the hydraulic lifting cylinder that extends the scissors linkages. The drive wheel assemblies are bolted to the base trusses to facilitate rapid disassembly and reassembly. The air powered pump and hydraulic drives are non-spark producing, requiring no external electrical power source to operate.

3. A power unit. The power unit consists of an air motor driven hydraulic pump, which is controlled by pneumatic and hydraulic valves. The machine is controlled by a system of valves that enable the operator to control all functions of the machine from the platform and also at ground level. The machine utilizes an over-tilt air operated safety shut down device. This shutdown device contains an inverted vertical pendulum that may be pre-set to activate at predetermined angular values. The device will immediately shut down power to critical machine functions if the machine is tilted to the pre-determined value. The power unit also includes a safety reserve air tank that will allow controlled descent in the event of loss of supply air pressure.

4. Machine scissor linkages. The scissor style linkages are extended by use of a hydraulic ram acting on the scissor members. The machine scissor linkages are fabricated from lightweight aluminum to facilitate positioning and assembling. The aluminum construction also greatly reduces the overall transport weight of the machine and reduces the load bearing requirements of the supporting floor. The lower scissor guides are shielded to prevent the buildup of paint and sand on critical sliding components of the scissor linkages. The machine utilizes a series of hooks attached to the scissors pin hinges for conveyance of heavy large diameter hoses and other support utilities to the platform. The conveyance system allows the scissor linkages to be extended and retracted without manual manipulation of the supply utilities.
